(19) United States
(12) Patent Application Publication
(10) Pub. No.: US 2026/0249737 A1
(43) Pub. Date: Aug. 27, 2026

(54) SYSTEM AND METHOD OF SMART CHARGING FOR OFFLINE ELECTRIC VEHICLE SUPPLY EQUIPMENTS (EVSES)

(71) Applicant: Siemens Industry, Inc., Alpharetta, GA (US)

(72) Inventors: Daniel Feldman, New York, NY (US); John Porter, Nicholson, GA (US)

(73) Assignee: Siemens Industry, Inc., Alpharetta, GA (US)

(21) Appl. No.: 19/065,104

(22) Filed: Feb. 27, 2025

(51) Int. Cl. B60L 53/68; B60L 53/64; B60L 53/67

(52) U.S. Cl. CPC B60L 53/68; B60L 53/64; B60L 53/67

(57) ABSTRACT

An electric vehicle (EV) charger, a charging station (CS) or electric vehicle supply equipment (EVSE) comprises a processor (P) and a memory (M) storing code (machine executable instructions) in EVSEs connected with a charging station management system (CSMS), a specialized app and a server over a network. The machine executable instructions when executed by the processor, cause the processor to perform smart charging of one or more offline EVSEs. A platform of a smart charging system based on smart charging instructions and confirmation that an EV charger adopted the smart charging instructions is disclosed. While particular embodiments are described in terms of offline EVSEs including a novel software code, a CSMS, a novel user device app and a server connected over a network, the techniques described herein are not limited to such combination but can also be used with other combinations of components implemented in EV hardware or EV software.

### BACKGROUND

### 1. Field

Aspects of the present disclosure generally relate to smart charging with an offline Electric Vehicle Supply Equipment (EVSE).

### 2. Description of the Related Art

Unlike gas-powered vehicles, EVs do not require internal combustion engines to operate. Sales of EVs are expected to expand rapidly across the world in the coming years. A number of market forecasts indicate electric vehicles will account for nearly 1 in 5 of all vehicles sold within the next 10 years. It is estimated approximately 3 million EVs will be sold in the US in 2028. A rule of thumb by industry analysts is that there need to be about 1 public EVC station per 20 EVs on the road to support the ecosystem. There were just over 60,000 charging stations in the US at the end of 2019. Thus, tens of thousands will need to be deployed every year for some time as the market grows.

Charging stations have provided hundreds of millions of charges to EV (electric vehicle) drivers worldwide. When it comes to electric vehicles, the converter is built inside the car. It's called the “onboard charger” though it really is a converter. It converts power from AC to DC and then feeds it into the car's battery. This is the most common charging method for electric vehicles today and most chargers use AC power.

An EV is connected to AC power, 120V or 240V, and a battery charger in the EV converts the AC power to the DC needed to charge the battery and controls the charging process. In DCFC the DCFC converts the AC power to DC and the DC power is sent directly to the EV battery bypassing the onboard battery charger. There are three categories or types of charging: Trickle Charge, AC Charge and DC Charge. Most drivers of electric vehicles (EVs)—which include all-electric vehicles and plug-in hybrid electric vehicles (PHEVs)—charge their vehicles overnight at home using AC Level 1 or AC Level 2 charging equipment. A charging station, also known as a charge point or electric vehicle supply equipment (EVSE), is a piece of equipment that supplies electrical power for charging plug-in electric vehicles (including electric cars, electric trucks, electric buses, neighborhood electric vehicles, and plug-in hybrids). Charging stations have provided hundreds of millions of charges to EV drivers worldwide.

In order to use a charging station, a user must connect an EV to the charging station and the charging station must authenticate the user to charge the user for the charging session. In most cases, the charging station is connected to a charging station operator via an Internet connection, and the authentication of the user is performed online via the charging station operator. As a result, in situations when the Internet connection of the charging station is down, the charging station cannot authenticate users and therefore cannot enable, or properly charge for, charging sessions.

Electric Vehicle Supply Equipments (EVSEs) that are offline normally cannot be used in smart charging applications where charging times are programmed to the EV charger remotely, and also cannot participate in day ahead demand response programs, because traditionally these require configuration by the charging management system and the ability for driver overrides, and this is impossible with offline chargers.

Traditionally, EV chargers had to made fully online in order to be configured.

Therefore, a platform that allows smart charging with an offline Electric Vehicle Supply Equipment (EVSE) is needed.

### SUMMARY

Briefly described, aspects of the present disclosure relate to a platform that allows smart charging with an offline Electric Vehicle Supply Equipment (EVSE). The present disclosure allows authenticating drivers and grabbing charging session information from an EVSE to the Charging Management System (CMS), allowing normal charging to occur, with smart charging. In a system, when the phone (or electric vehicle) is connected to the EV charger via Bluetooth or another wireless interface in an authenticated manner, the phone delivers to the charger OCPP (Open Charge Point Protocol (OCPP) is an open-source communication standard that allows electric vehicle (EV) charging stations to communicate with each other) Smart Charging Profile configuration messages of OCPP 1.6J, 2.0.1, 2.1 or later variants (See OCPP—Open Charge Alliance), with a timestamp of when the configuration was last changed on the CMS. An app on the phone (or the electric vehicle) compares the timestamp of the configuration (phone time acquisition, in case the phone lost energy and then uses the latest configuration. If the configuration coming from the phone is newer than the previously stored one, it informs the phone. In exemplary embodiments, the above set forth configuration can be achieved as shown and described in U.S. patent application Ser. No. 18/168,914 entitled ACQUIRING TIME FOR AN ELECTRIC VEHICLE SUPPLY EQUIPMENT (EVSE) BASED ON A SHORT-RANGE WIRELESS COMMUNICATION-BASED AUTOMATED PROCESS, which was filed on Feb. 14, 2023.

When the phone, vehicle, or EVSE has internet connectivity, it informs the CMS about the EVSE having received the OCPP configuration information related to Smart Charging. This method can be used for all OCPP configuration messages, especially how smart charging is used.

If upon connection between the EV charger and electric vehicle the state of charge of the electric vehicle is given to the EV charger via ISO15118-20, the EV charger provides the electric vehicle State of Charge to the app on the phone. If the app is running on the electric vehicle, State of Charge is known.

While using Smart Charging profiles is useful to ensure charging happens when it is most preferable for either the driver (to reduce electricity costs for the driver) or the utility (to avoid bottlenecks on the grid), drivers may be allowed to override smart charging events. In these cases, normally drivers need to receive a notification about the impact of overriding (e.g. you will pay a higher electricity rate), and then be allowed to nevertheless override, allowing the driver to charge the electric vehicle.

Therefore, if upon plugging the electric vehicle authenticating, charging is not to start immediately because the smart charging profile determines that this is not a good time to charge, the driver should be allowed to override and initiate charging. In this scenario, the app would generate an additional Smart Charging profile with higher priority that enables charging for enough time to charge the electric vehicle battery, based on the electric vehicle battery size configured on the app, or the State of Charge of the electric vehicle battery (if known), or a maximum logical size for a battery and the minimum between the maximum output power of an EV charger of this model and the maximum power consumption vehicle of this type.

This charging profile and the fact that the driver overrode the default configuration is then registered at the CMS, once the phone, electric vehicle (or EVSE) has connection with the CMS, as this can change the benefits the driver receives if the driver is enrolled in a utility day ahead demand response program.

In accordance with one illustrative embodiment of the present disclosure, a method of smart charging for offline Electric Vehicle Supply Equipments (EVSEs) is disclosed. The method comprises load balancing between electric vehicle (EV) chargers by making changes to power/current allocated to the EV chargers in a load balancing group. The method further comprises performing changes in power allocation between the EV chargers when one or more of the EV chargers in the load balancing group is offline, using a user device such as a smartphone as a commands bridge and on top of messages sent from an EV charger to a server via the smartphone, the server indicating a last time stamp sent. The server also sends smart charging instructions according to Open Charge Point Protocol (OCPP) standard thus allowing the smart charging to happen with any EV chargers that are offline. The Open Charge Point Protocol (OCPP) standard is an open-source communication standard that allows electric vehicle (EV) charging stations and management systems including a Charging Station Management System (CSMS) to communicate with each other and the Charging Station Management System (CSMS) is a software platform that manages multiple electric vehicle (EV) charging stations for electric vehicles (EVs).

In accordance with one illustrative embodiment of the present disclosure, a system of smart charging for offline Electric Vehicle Supply Equipments (EVSEs). The system comprises a smart phone App as a baseline App, an Electric Vehicle (EV) charger embedded software code that is configured to receive commands through Open Charge Point Protocol (OCPP) (standard communication) to perform smart charging such that the EV charger embedded software code is configured to receive commands from a smart phone application (App) interface that establishes a connectivity between the smart phone App and an EV charger and a Charging Station Management System (CSMS). The smart phone App stores communication and commands to/from the Charging Station Management System (CSMS) and the EV Charger embedded software code and also stores-and-forwards commands and responses related to the smart charging. The CSMS is configured to send smart charging commands through a direct communication with the EV charger via the OCPP such that it establishes a way for the CSMS to use the smart phone App as a bridge to send/receive information to the EVSE, instead of using standard communication channels while adding to a list of messages that are sent/received messages related to the smart charging. The Open Charge Point Protocol (OCPP) standard is an open-source communication standard that allows electric vehicle (EV) charging stations and management systems including the Charging Station Management System (CSMS) to communicate with each other and the Charging Station Management System (CSMS) is a software platform that manages multiple electric vehicle (EV) charging stations for electric vehicles (EVs).

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 illustrates a block diagram of a computing system in accordance with one or more embodiments of the present disclosure.

FIG. 2A illustrates a block diagram of a system for certificate-based authentication for a charging session of an electric vehicle in accordance with an embodiment of the present disclosure.

FIG. 2B illustrates a block diagram of a charging session data log in accordance with an embodiment of the present disclosure.

FIG. 2C illustrates a block diagram of a committed charging station data set in accordance with an embodiment of the present disclosure.

FIG. 3 illustrates a flow chart diagram of a method for certificate-based authentication for a charging session of an electric vehicle in accordance with an embodiment of the present disclosure.

FIG. 4A and FIG. 4B illustrate a block diagram of the communication between a charging station, a user device, and a charging station operator during certificate-based authentication for a charging session of an electric vehicle in accordance with an embodiment of the present disclosure.

FIG. 5 illustrates a flow chart diagram of a method for certificate-based authentication for a charging session of an electric vehicle in accordance with an embodiment of the present disclosure.

FIG. 6 illustrates a flow chart diagram of a method for providing a committed charging station data set to a user device in accordance with an embodiment of the present disclosure.

FIG. 7 illustrates a flow chart diagram of a method for distributed charging session data transfer between a charging station and a charging station operator in accordance with an embodiment of the present disclosure.

FIG. 8 illustrates a system for acquiring time for an Electric Vehicle Supply Equipment (EVSE) based on a short-range wireless communication-based automated process in accordance with a first embodiment of the present disclosure.

FIG. 9 illustrates a schematic view of a flow chart of a method for acquiring time for an Electric Vehicle Supply Equipment (EVSE) based on a short-range wireless communication-based automated process in accordance with an embodiment of the present disclosure.

FIG. 10 illustrates a platform for smart charging with an offline Electric Vehicle Supply Equipment (EVSE) in accordance with an embodiment of the present disclosure.

FIG. 11 illustrates a system for smart charging with an offline Electric Vehicle Supply Equipment (EVSE) in accordance with an embodiment of the present disclosure.

FIG. 12 illustrates a charging station/an Electric Vehicle Supply Equipment (EVSE) in accordance with an embodiment of the present disclosure.

FIG. 13 illustrates a schematic view of a flow chart for a method of smart charging with an offline Electric Vehicle Supply Equipment (EVSE) according to an embodiment of the present disclosure.

### DETAILED DESCRIPTION

Various technologies pertain to a platform that provides a system for smart charging with an offline Electric Vehicle Supply Equipment (EVSE). The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

To facilitate an understanding of embodiments, principles, and features of the present disclosure, they are explained hereinafter with reference to implementation in illustrative embodiments. In particular, they are described in the context of a platform that provides a system for smart charging with an offline Electric Vehicle Supply Equipment (EVSE). Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

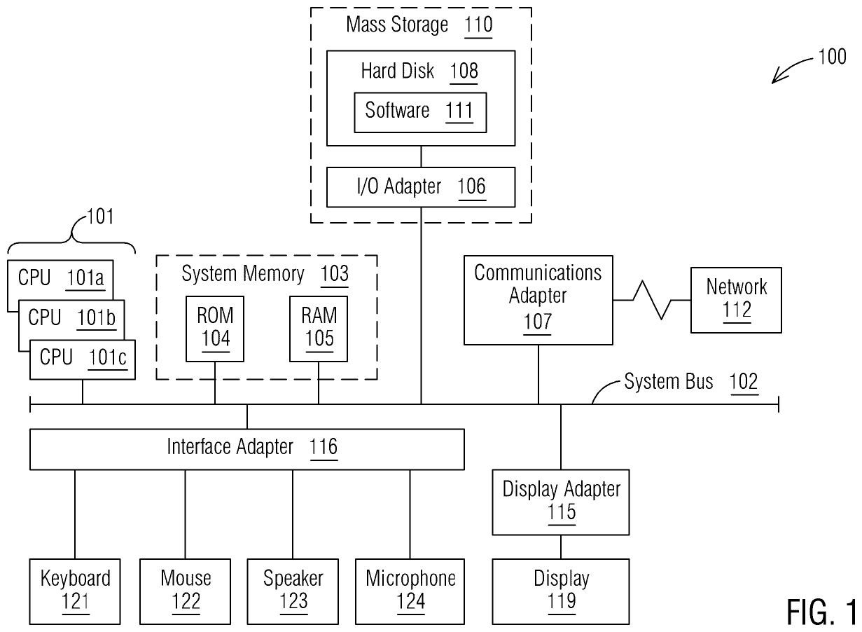

These and other embodiments of the system are provided for a platform that provides a system for smart charging with an offline Electric Vehicle Supply Equipment (EVSE) according to the present disclosure are described below with reference to FIGS. 1-11 herein. The drawings are not necessarily drawn to scale.

The term electric vehicle (EV), as used herein, refers to a motorized vehicle deriving locomotive power, either full-time or part-time, from an electric system on board the motorized vehicle. By way of non-limiting examples, an EV may be an electrically powered passenger vehicle for road use; an electric scooter; an electric forklift; a cargo-carrying vehicle powered, full-time or part-time, by electricity; an off-road electrically powered vehicle; an electrically powered watercraft; etc.

The term electric vehicle supply equipment (EVSE), as used herein, refers to equipment by which an EV may be charged or recharged. An EVSE may comprise or be coupled to a computing system whereby service to the EV is provisioned, optionally, according to parameters. In some embodiments, values for the parameters are operator selectable. Alternatively, or in addition, the values for the parameters may be automatically selected. An EVSE may comprise a means of providing cost accounting, and may further comprise a payment acceptance component. An EVSE may be installed at a home or residence of an owner/operator of an EV, at a place of business for an owner/operator of an EV, at a fleet facility for a fleet comprising one or more EVs, at a public charging station, etc. The present disclosure uses the terms EVSE and “charging station,” where for purposes of this disclosure, an EVSE is an example of a charging station. Alternatively, an EVSE may mean a power supplying device that supplies power to EVs regardless of form (electric cars, trucks, buses, neighborhood electric vehicles or people transport vehicles that utilize AC or DC current to transfer power) and with or without additional power transferring components such as transceivers, or inverters etc.

An EVSE may be portable such that it can be brought by a user to various locations and used to charge an EV. For example, a user may install and use an EVSE at home to charge an EV. The user may then travel to a friend or family member's home, bringing the EVSE, and install and use the EVSE to charge the EV at the friend or family member's home.

Charging stations are normally connected to a charging station operator via an Internet connection, and the authentication of the user is performed online via the charging station operator. In many cases, charging stations are located on lower levels of parking decks under high-rise buildings or in other environments where cellular network reception is poor or non-existent. Such charging stations may be connected to the Internet via a hardwired or wireless connection, which may experience periodic outages. When the Internet connection of a charging station is unavailable, or offline, the charging station cannot authenticate users and therefore cannot enable, or properly charge for, charging sessions.

An electric vehicle (EV) charger, a charging station (CS) or electric vehicle supply equipment (EVSE) comprises a processor (P) and a memory (M) storing code (machine executable instructions) in EVSEs connected with a charging station management system (CSMS), a specialized app and a server over a network. The machine executable instructions when executed by the processor, cause the processor to perform smart charging of one or more offline EVSEs. A platform of a smart charging system based on smart charging instructions and confirmation that an EV charger adopted the smart charging instructions is disclosed. While particular embodiments are described in terms of offline EVSEs including a new software code, a CSMS, a new user device app and a server connected over a network, the techniques described herein are not limited to such combination but can also be used with other combinations of components implemented in EV hardware or EV software.

Referring now to FIG. 1, a computing system 100 is generally shown in accordance with one or more embodiments of the invention. The computing system 100 can be an electronic, computer framework comprising and/or employing any number and combination of computing devices and networks utilizing various communication technologies, as described herein. The computing system 100 can be easily scalable, extensible, and modular, with the ability to change to different services or reconfigure some features independently of others. The computing system 100 may be, for example, a server, desktop computer, laptop computer, tablet computer, or smartphone. In some examples, computing system 100 may be a cloud computing node. Computing system 100 may be described in the general context of computer system executable instructions, such as program modules, being executed by a computer system. Generally, program modules may include routines, programs, objects, components, logic, data structures, and so on that perform particular tasks or implement particular abstract data types. Computing system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1 the computing system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read-only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computing system 100. The RAM is read-write memory coupled to the system bus 102 for use by the processors 101. The system memory 103 provides temporary memory space for operations of said instructions during operation. The system memory 103 can include random access memory (RAM), read-only memory, flash memory, or any other suitable memory systems.

The computing system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computing system 100 may be stored in the mass storage 110. The mass storage 110 is an example of a tangible storage medium readable by the processors 101, where the software 111 is stored as instructions for execution by the processors 101 to cause the computing system 100 to operate, such as is described herein below with respect to the various Figures. Examples of computer program products and the execution of such instruction are discussed herein in more detail. The communications adapter 107 interconnects the system bus 102 with a network 112, which may be an outside network, enabling the computing system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computing system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the Internet small computer system interface, among others. The network 112 may be a cellular network, a radio network, a wide area network (WAN), a local area network (LAN), or the Internet, among others. An external computing device may connect to the computing system 100 through the network 112. In some examples, an external computing device may be an external webserver or a cloud computing node.

It is to be understood that the block diagram of FIG. 1 is not intended to indicate that the computing system 100 is to include all of the components shown in FIG. 1. Rather, the computing system 100 can include any appropriate fewer or additional components not illustrated in FIG. 1 (e.g., additional memory components, embedded controllers, modules, additional network interfaces, etc.). Further, the embodiments described herein with respect to computing system 100 may be implemented with any appropriate logic, wherein the logic, as referred to herein, can include any suitable hardware (e.g., a processor, an embedded controller, or an application-specific integrated circuit, among others), software (e.g., an application, among others), firmware, or any suitable combination of hardware, software, and firmware, in various embodiments.

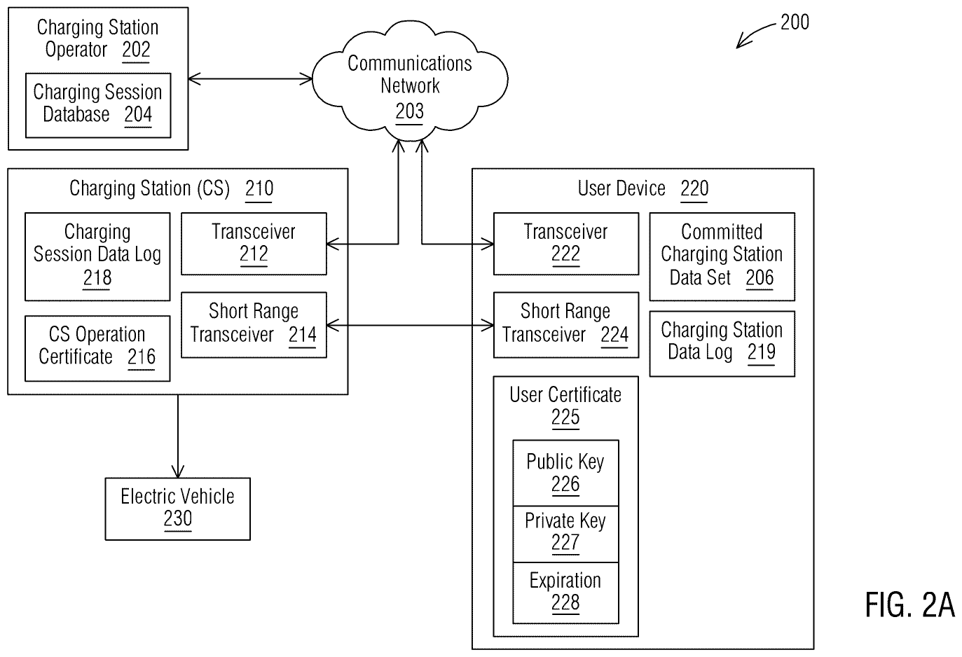

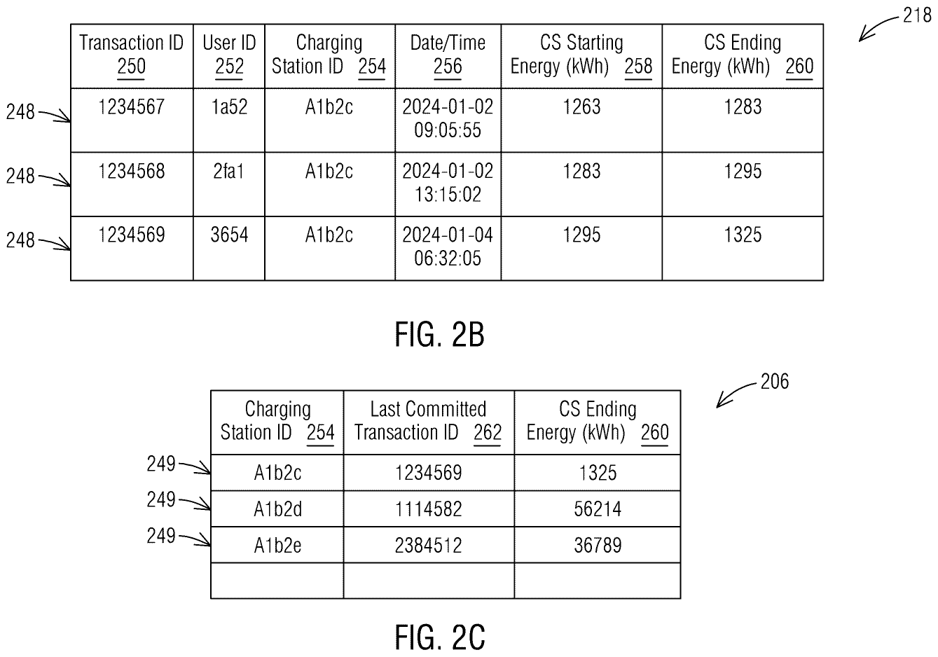

Referring now to FIG. 2A, a block diagram illustrating a system 200 for certificate-based authentication for a charging session of an electric vehicle in accordance with one or more embodiments of the invention is shown. As illustrated, the system 200 includes a charging station 210, a charging station operator 202 of the charging station 210, a user device 220, and an electric vehicle 230 corresponding to the user device 220. In exemplary embodiments, the charging station 210, the charging station operator 202, and the user device 220 include a processing system, such as the computing system 100 shown in FIG. 1.

In exemplary embodiments, the charging station 210 includes a transceiver 212 that provides a connection to a communications network 203. The communications network 203 may include a combination of private and public networks, such as the Internet. The charging station 210 is configured to communicate with the charging station operator 202 via an Internet connection over the communications network 203. Likewise, the user device 220 includes a transceiver 222 that provides a connection to the charging station operator 202 via the communications network 203. In one embodiment, the user device 220 is a smartphone or other similar device that is associated with an operator of the electric vehicle 230. In exemplary embodiments, when both the charging station 210 and the user device 220 are able to communicate with the charging station operator 202 via the communications network 203, one or more of the charging stations 210 and the charging station operator 202 are configured to authenticate the user device 220 and activate a charging session for an electric vehicle 230.

From time to time, the charging station 210 may not be able to communicate with the charging station operator 202 via the communications network 203, i.e., the Internet connection of the charging station 210 is down. In such cases, the charging station 210 is configured to perform a certificate-based authentication for a charging session of the electric vehicle 230 by communicating directly with the user device 220. In exemplary embodiments, the charging station 210 includes a short-range transceiver 214 and the user device 220 includes a short-range transceiver 224. The short-range transceiver 214 and the short-range transceiver 224 are configured to facilitate communication between the charging station 210 and the user device 220 via a personal area network protocol, such as Bluetooth, Near-Field Communication (NFC), or the like.

In exemplary embodiments, the user device 220 includes a user certificate 225 that may be obtained from the charging station operator 202. In one embodiment, the user certificate includes a public key 226, a private key 227, and an expiration date/time 228 of the user certificate. The charging station 210 includes a charging station operation certificate 216 that is obtained from the charging station operator 202. In exemplary embodiments, during the authentication process, the user device 220 provides the user certificate 225 to the charging station 210, which utilizes the public key 226 along with data stored in the charging station operation certificate 216 to authenticate the user device 220 and responsively enable a charging session of the electric vehicle 230.

In exemplary embodiments, the charging station 210 is configured to create and store a charging session data log 218 that includes relevant data corresponding to the charging session. FIG. 2B illustrates a block diagram of the charging session data log 218 in accordance with an embodiment of the present disclosure. As illustrated, the charging session data log 218 includes a plurality of entries 248 that each correspond to a charging session and each entry includes a unique transaction ID 250, a user device ID 252, a charging station ID 254, a date/time stamp 256, a total energy provided by the charging station at the start of the charging session (CS Starting Energy) 258, and a total energy provided by the charging station at the end of the charging session (CS Ending Energy) 260. In exemplary embodiments, the charging station 210 is configured to add an entry 248 to the charging session data log 218 at the completion of each charging station. In addition, the charging station 210 is configured to delete an entry 248 from the charging stations to the charging session data log 218 based on a determination that the charging station operator 202 has received the data corresponding to the entry 248.

In exemplary embodiments, the charging station 210 includes a real time clock that is utilized to generate the date/time stamp 256. When the charging station 210 is online, (i.e., connected to the Internet) the real time clock is periodically checked to ensure that the real time clock is correct. However, when the charging station 210 is offline, the real time clock may begin to drift and become incorrect. In exemplary embodiments, the real time clock can be corrected using communication with connected user devices, such as shown and described in U.S. patent application Ser. No. 18/168,914 entitled ACQUIRING TIME FOR AN ELECTRIC VEHICLE SUPPLY EQUIPMENT (EVSE) BASED ON A SHORT-RANGE WIRELESS COMMUNICATION-BASED AUTOMATED PROCESS, which was filed on Feb. 14, 2023.

In exemplary embodiments, the charging station operator 202 includes a charging session database 204 that includes an identification of all of the charging stations 210 that are operated by the charging station operator 202. The charging session database 204 includes a charging station ID for each charging station 210 and the geographical location of each charging station 210. The charging session database 204 is configured to receive data from the charging session data log 218 that is created by the charging stations 210.

During normal operations, i.e., when the Internet connection between the charging station 210 and the charging station operator 202 is available, the charging station 210 is configured to periodically transmit the data from the charging session data log 218 to the charging station operator 202 and to purge the transmitted data from the charging session data log 218 once an acknowledgement is received from the charging station operator 202 that the data from the charging session data log 218 has been received and stored in the charging session database 204.

In exemplary embodiments, the charging station operator 202 is configured to create and transmit a committed charging station data set 206 to a user device 220. The committed charging station data set 206 indicates for a set of charging stations 210 the most recently received charging session data that has been received by the charging station operator 202. FIG. 2C illustrates a block diagram of a committed charging station data set 206 in accordance with an embodiment of the present disclosure. As illustrated, the charging station data set 206 includes a plurality of entries 249 that each correspond to a charging station 210, each entry 249 includes a charging station ID 254, a last committed transaction ID 262, and a total energy provided by the charging station at the end of the charging session (CS Ending Energy) 260. In exemplary embodiments, the charging station operator 202 is configured to periodically create the committed charging station data set 206 that is transmitted to a user device 220 based on the location of the user device 220 and based on the data in the charging session database 204. In exemplary embodiments, the charging station operator 202 is configured to include charging stations 210 located within a predetermined distance of the user device 220 in the committed charging station data set 206.

In exemplary embodiments, when a charging station 210 is offline (i.e., not in communication with the charging station operator 202 via the communications network 203), the charging station 210 is configured to perform unrestricted charging (i.e., the charging station 210 is configured to enable a charging session without authentication of the user device 220). In these cases, the charging station 210 will still record charging session data in a charging session data log 218. Although the user device 220 may not be authenticated, the charging station 210 is still configured to transmit the charging session data log 218 to the user device 220 and to obtain a committed charging station data set 206 from the user device 220. Further, the charging station 210 is configured to update the charging session data log 218 based on the committed charging station data set 206 received from the user device 220.

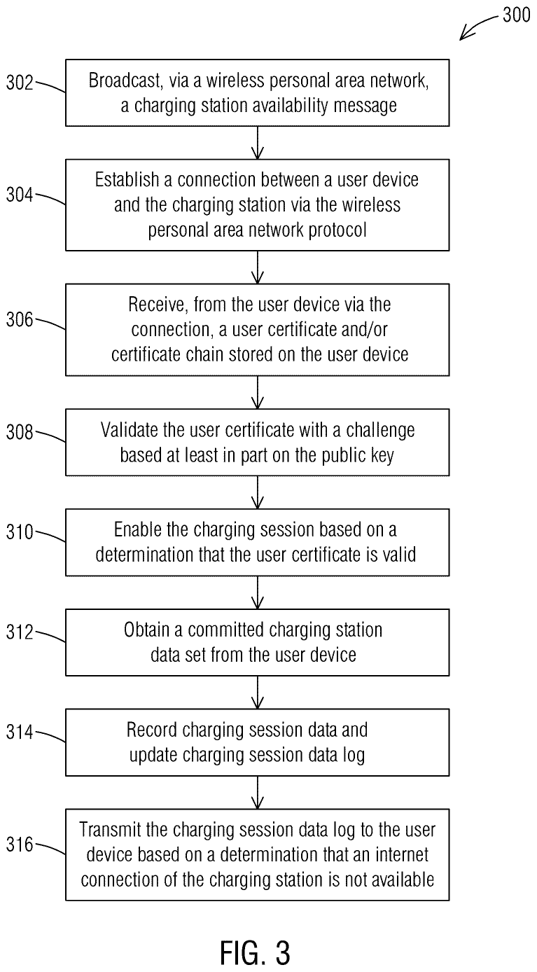

Referring now to FIG. 3, a flowchart illustrating a method 300 for performing certificate-based authentication for a charging session of the electric vehicle in accordance with one or more embodiments of the invention is shown. In exemplary embodiments, the method 300 is performed by a processing system of a charging station, such as the charging station 210 shown in FIG. 2. The method 300 includes broadcasting, via a wireless personal area network protocol, a charging station availability message. In exemplary embodiments, the personal area network protocol is Bluetooth. In one embodiment, the charging station availability message includes one or more of the available powers from the charging station, a maximum charging rate available from the charging station, a cost per kilowatt-hour for power provided by the charging station, and an available charging time of the charging station until a next reservation.

Next, as shown at block 304, the method 300 includes establishing a connection between a user device 220 and the charging station 210 via the wireless personal area network protocol. In exemplary embodiments, the user device 220 is a mobile phone or other processing system that is associated with an operator of an electric vehicle. The method 300 also includes receiving, by the charging station from the user device 220 via the connection, a user certificate and/or certificate chain stored on the user device 220, as shown at block 306. In exemplary embodiments, the user device 220 includes a user certificate that is associated with the user and the user certificate includes a public key, a private key, and an expiration date/time of the user certificate. In one embodiment, the user certificate is obtained by the user device 220 from a charging station operator.

Next, as shown at block 308, the method 300 includes validating, by the charging station, the user certificate with a challenge based at least in part on the public key. In exemplary embodiments, the validation of the public key of the user certificate is performed offline, i.e., the authentication of the user certificate is performed locally by the charging station and does not require or utilize a connection to the Internet to perform the validation. In one embodiment, validating the user certificate includes generating a nonce value, creating an encrypted nonce by encrypting the nonce value using the public key, transmitting the encrypted nonce to the user device 220, receiving a decrypted nonce value from the user device 220, and determining that the user certificate is valid based on a determination that the decrypted nonce value equals the nonce value. Validating the user certificate may also include verifying that the user certificate has not expired based on the expiration date/time of the user certificate.

The method 300 also includes enabling the charging session based on a determination by the charging station that the user certificate is valid, as shown at block 310. After the charging session has been enabled, the charging station is configured to charge an electric vehicle that is connected to the charging station. As shown at block 312, the method 300 includes obtaining a committed charging station data set 206 from the user device 220. Next, as shown at block 316, the method 300 includes recording charging session data and updating the charging session data log 218. In exemplary embodiments, updating the charging session data log 218 includes creating a new entry corresponding to the completed charging session. In exemplary embodiments, updating the charging session data log 218 includes deleting entries of the charging session data log 218 that have been successfully received and stored by the charging station operator based on the committed charging station data set 206. In exemplary embodiments, the charging session data log 218 includes a charging station identifier, an identifier of the user device 220, the total power provided during the charging session, and the total power provided by the charging station during the lifetime of the charging station. After the charging session has ended, the method 300 includes transmitting the charging session data log 218 to the user device 220 based on a determination that an internet connection of the charging station is not available, as shown at block 316. In exemplary embodiments, the user device 220 is configured to transmit the charging session data log 218 to the charging station operator 202 of the charging station 210 once the user device 220 is connected to the Internet. In exemplary embodiments, based on a determination that an internet connection of the charging station 210 is available, the charging station 210 is configured to transmit the charging session data log 218 to a charging station operator 202. In exemplary embodiments, charging session data log 218 is transmitted, by the charging station to the user device 220, based on a determination that the internet connection is not available. The charging session data log 218 includes data for one or more previous charging sessions that occurred while the internet connection of the charging station 210 was not available.

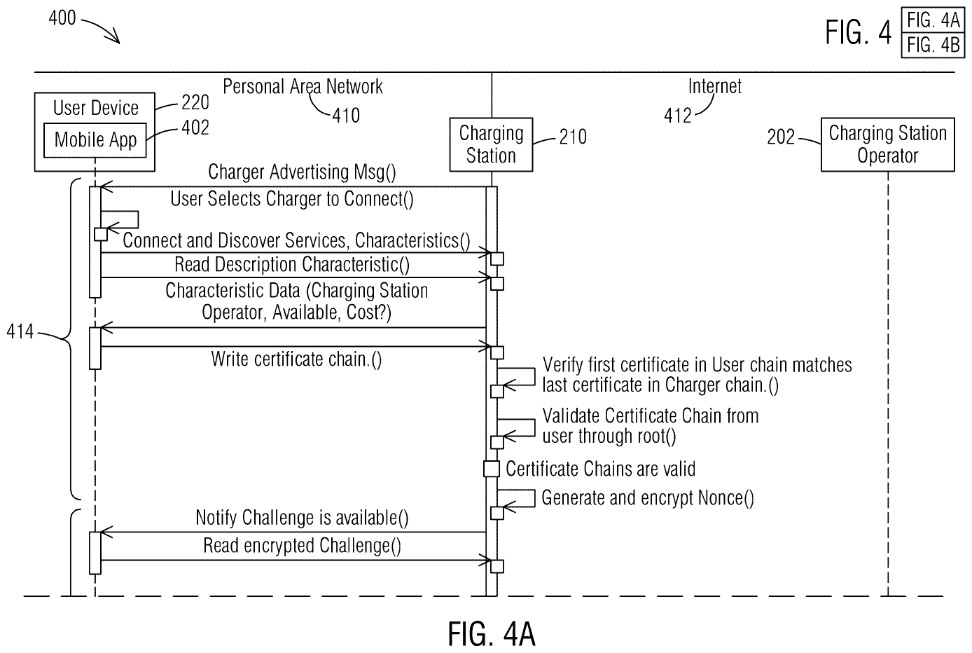

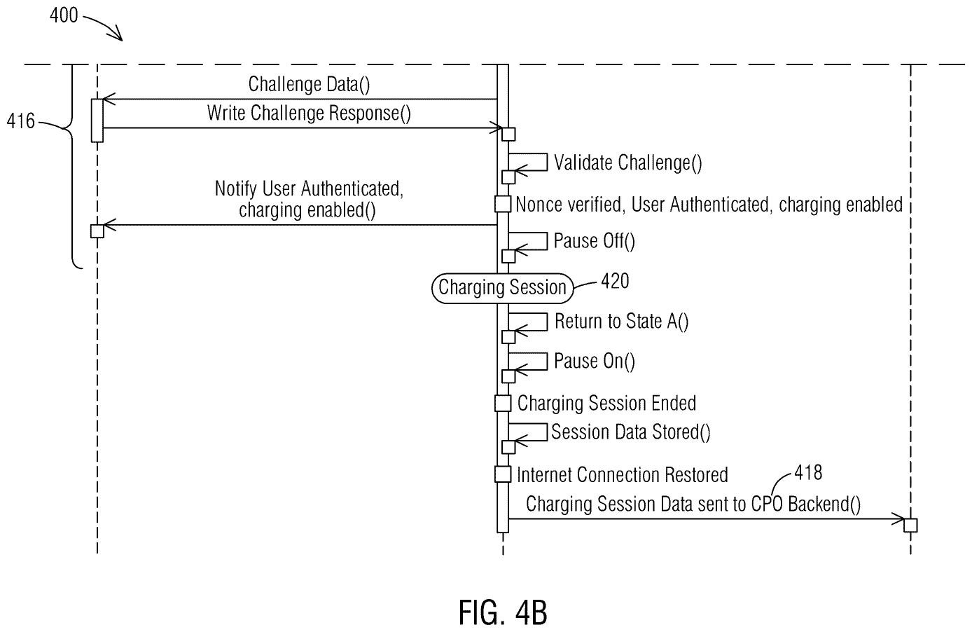

Referring now to FIG. 4A and FIG. 4B, a diagram illustrating a certificate-based authentication process 400 between a charging station 210, a user device 220, and a charging station operator 202 in accordance with one or more embodiments of the invention is shown. As illustrated, the certificate-based authentication process 400 includes communication between a user device 220 and a charging station 210, via a personal area network 410. In one embodiment, the personal area network 410 is a point-to-point connection between a mobile application 402 of the user device 220 and the charging station 210 using a personal area network protocol, such as Bluetooth. In addition, the certificate-based authentication process 400 includes communication between the charging station 210 and a charging station operator 202 via an Internet connection 412.

As illustrated, the authentication process 400 includes exchanging a series of messages 414 between the mobile application 402 of the user device 220 and the charging station 210 to establish a communications channel between the user device 220 and the charging station 210. The authentication process 400 also includes exchanging a series of messages 416 between a mobile application 402 on the user device 220 and the charging station 210 to validate a user certificate of the user device 220. In addition, the authentication process 400 includes transmitting one or more messages 418 from the charging station 210 to the charging station operator 202 via an Internet connection 412 to provide the charging station operator 202 with data from a charging session 420.

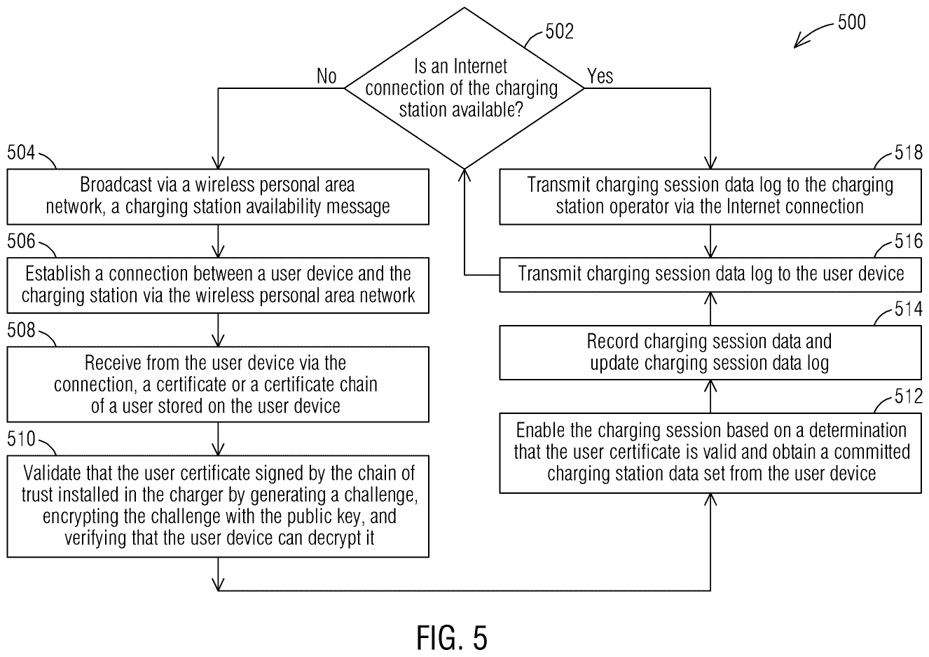

Referring now to FIG. 5, a flowchart illustrating a method 500 for performing certificate-based authentication for a charging session of an electric vehicle in accordance with one or more embodiments of the invention is shown. In exemplary embodiments, the method 500 is performed by a processing system of a charging station, such as the charging station 210 shown in FIG. 2. As shown at decision block 502, the method 500 includes determining whether an Internet connection to the charging station is available. Based on a determination that the Internet connection of the charging station is not available, the method 500 includes broadcasting, via a wireless personal area network protocol, a charging station availability message. In exemplary embodiments, the personal area network is a Bluetooth network. In one embodiment, the charging station availability message includes one or more of the available powers from the charging station, a maximum charging rate available from the charging station, a cost per kilowatt-hour for power provided by the charging station, and an available charging time of the charging station until a next reservation.

Next, as shown at block 506, the method 500 includes establishing a connection between a user device and the charging station via the wireless personal area network protocol. In exemplary embodiments, the user device is a mobile phone or other processing system that is associated with an operator of an electric vehicle. The method 500 also includes receiving, by the charging station from the user device via the connection, a user certificate and/or certificate chain stored on the user device, as shown at block 508. In exemplary embodiments, the user device includes a user certificate that is associated with the user and the user certificate includes a public key, a private key, and an expiration date/time of the user certificate. In one embodiment, the user certificate is obtained by the user device from a charging station operator.

Next, as shown at block 510, the method 500 includes validating, by the charging station, the that user certificate was signed by the chain of trust installed in the charging station by generating a challenge (i.e., a nonce value), encrypting the nonce value with the users public key, and verifying that the user can decrypt it In exemplary embodiments, the validation of the public key of the user certificate is performed offline, i.e., the authentication of the user certificate is performed locally by the charging station and does not require or utilize a connection to the Internet to perform the validation. In one embodiment, validating the user certificate includes generating a nonce value, creating an encrypted nonce by encrypting the nonce value using the public key, transmitting the encrypted nonce to the user device, receiving a decrypted nonce value from the user device, and determining that the user certificate is valid based on a determination that the decrypted nonce value equals the nonce value. Validating the user certificate may also include verifying that the user certificate has not expired based on the expiration date/time of the user certificate.

The method 500 also includes enabling the charging session based on a determination by the charging station that the user certificate is valid and obtaining a committed charging station data set from the user device, as shown at block 512. After the charging session has been enabled, the charging station is configured to charge an electric vehicle that is connected to the charging station. As shown at block 514, the method 500 includes recording charging session data and updating the charging session data log 218. In exemplary embodiments, updating the charging session data log 218 includes creating a new entry corresponding to the completed charging session. In exemplary embodiments, updating the charging session data log 218 includes deleting entries of the charging session data log 218 that have been successfully received and stored by the charging station operator based on the committed charging station data set. In exemplary embodiments, the charging session data includes a charging station identifier, an identifier of the user device, the total power provided during the charging session, and the total power provided by the charging station during the lifetime of the charging station. After the charging session has ended, the method 500 includes transmitting the charging session data log 218 to the user device 220, as shown at block 516. In exemplary embodiments, the user device 220 stores the received charging session data log 218 in a charging station data log 219. In exemplary embodiments, based on a determination that the Internet connection of the charging station is available, the method 500 also includes transmitting the charging session data log 218 to the charging station operator 202 via the Internet connection.

In exemplary embodiments, transmitting the charging session data via both the user device and directly from the charging station to the charging station operator provides a redundant source of the charging session data to the charging station operator to ensure that all of the charging session data is received by the charging station operator. In exemplary embodiments, when the Internet connection of the charging station is available the methods used by the charging station to authenticate a user device may be the same, i.e., method steps 504 through 514, or an alternative method that utilizes an active Internet connection of the charging station may be used.

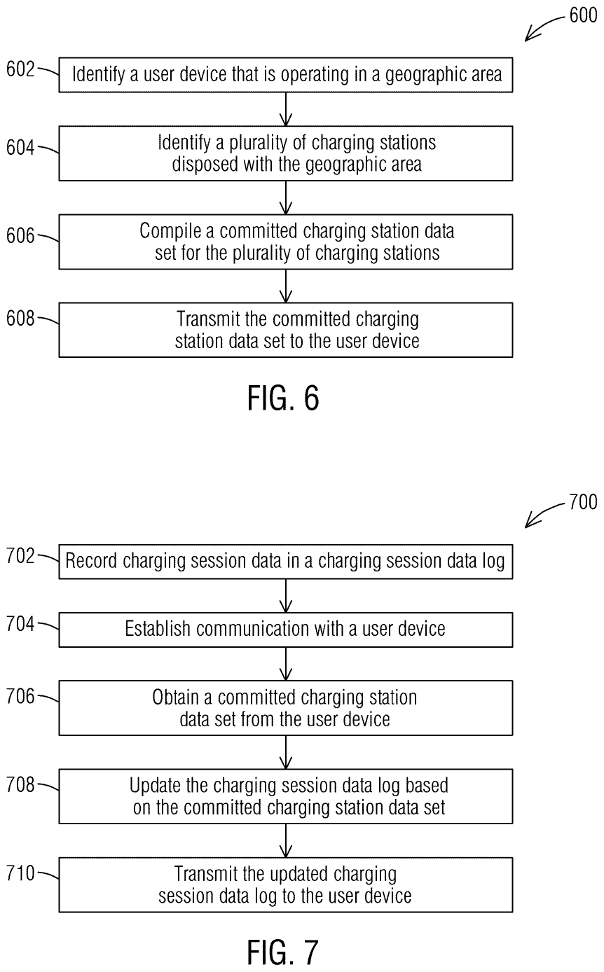

Referring now to FIG. 6, a flow chart diagram of a method 600 for providing a committed charging station data set to a user device in accordance with an embodiment of the present disclosure is shown. In exemplary embodiments, the method 600 is performed by a processing system of a charging station operator, such as the charging station operator 202 shown in FIG. 2. As shown at block 602, the method 600 includes identifying a user device that is operating in a geographic area. In exemplary embodiments, the charging station operator may periodically obtain the location of the user devices that are in communication with the charging station operator. Next, as shown at block 604, the method 600 includes identifying a plurality of charging stations disposed with the geographic area. The method 600 also includes compiling a committed charging station data set for the plurality of charging stations, as shown at block 606. Next, as shown at block 608, the method 600 includes transmitting the committed charging station data set to the user device.

Referring now to FIG. 7, a flow chart diagram of a method 700 for distributed charging session data transfer between a charging station and a charging station operator in accordance with an embodiment of the present disclosure is shown. In exemplary embodiments, the method 700 is performed by a processing system of a charging station, such as the charging station 210 shown in FIG. 2. As shown at block 702, the method 700 includes recording, by a charging station 210, charging session data in a charging session data log 218. In exemplary embodiments, the charging session data log 218 includes a plurality of entries that each correspond to a charging session performed by the charging station. Each entry includes a unique transaction ID, a user device ID, a charging station ID, a total energy provided by the charging station at the start of the charging session, and a total energy provided by the charging station at the end of the charging session.

Next, as shown at block 704, the method 700 includes establishing communication with a user device 220. In exemplary embodiments, the user device is a smartphone, and the communication is established via a personal area network. At block 706, the method 700 includes obtaining a committed charging station data set 206 from the user device 220. In exemplary embodiments, the committed charging station data set 206 includes an indication of the most recently received charging session data for the charging station 210 that has been received by a charging station operator 202 corresponding to the charging station 210. In exemplary embodiments, the user device 220 receives the committed charging station data set 206 from a charging station operator 202 based at least in part on a location of the user device 220, as explained in more detail above with reference to FIG. 6.

The method 700 also includes updating the charging session data log 218 based on the committed charging station data set 206. In exemplary embodiments, updating the charging session data log 218 includes deleting entries of the charging session data log 218 that have been received by a charging station operator 202 corresponding to the charging station 210. After the charging session data log 218 has been updated, the method 700 includes transmitting the updated charging session data log 218 to the user device 220, which stores the data from the charging session data log 218 in a charging station data log 219. In exemplary embodiments, the charging station data log 219 may include charging session data logs 218 from multiple charging stations 210. In exemplary embodiments, the user device 220 is configured to transmit the charging station data log 219 to the charging station operator 202, which utilizes the charging station data log 219 to update a charging session database 204 maintained by the charging station operator 202.

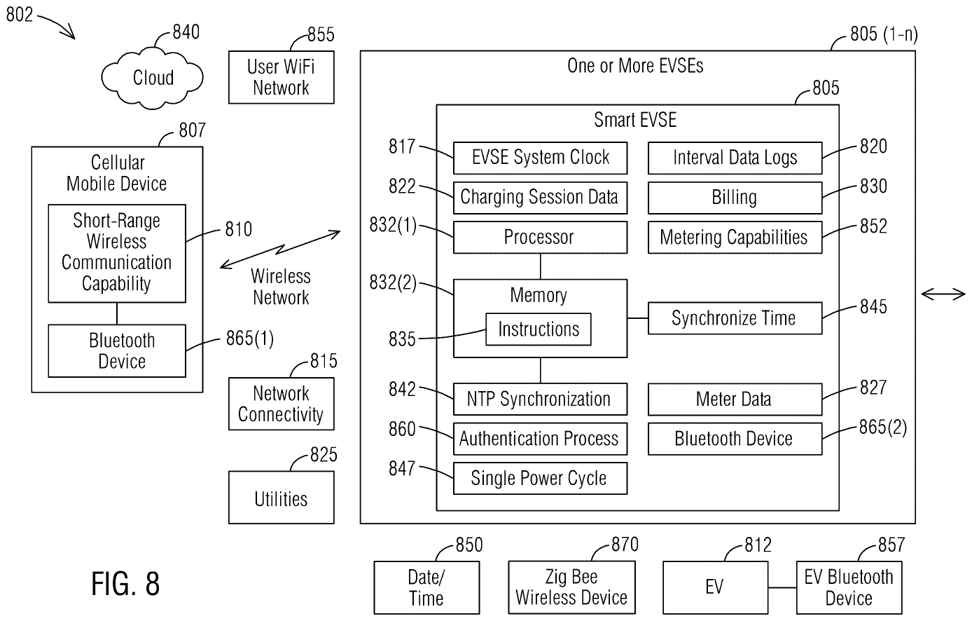

Consistent with one embodiment of the present disclosure, FIG. 8 represents a system 802 for a system clock time synchronization in accordance with a first embodiment of the present disclosure. The system 802 is configured to acquire time for a smart Electric Vehicle Supply Equipment (EVSE) 805 based on a short-range wireless communication-based automated process. The system 802 comprises a cellular mobile device 807 having a short-range wireless communication capability 810 to communicate on a wireless network with one or more EVSEs 805(1-n) that are configured to charge an electric vehicle (EV) 812 of a user.

The system 802 further comprises the smart EVSE 805 communicatively coupled to the cellular mobile device 807 of the user. The smart EVSE 805 is capable of gaining network connectivity 815, maintaining an EVSE system clock 817, and storing multiple days or months interval data logs 820 and charging session data 822 in order to provide reporting to a utility 825 that allows retroactively calculating meter data 827 and performing accurate billing 830 to its customers. The smart EVSE 805 comprises a processor 832(1) and a memory 832(2) storing instructions 835 that, when executed by the processor 832(1), cause the smart EVSE 805 to: use the short-range wireless communication capability 810 of the cellular mobile device 807 to synchronize time 845 if power is lost when the network connectivity 815 is down and to retrieve the interval data logs 820 and the charging session data 822 for updating to a cloud 840 automatically to gain network connectivity 815 for gaining an ability to perform Network Time Protocol (NTP) synchronization 842 of the EVSE system clock 817.

Network Time Protocol (NTP) is an internet protocol used to synchronize with computer clock time sources in a network. It belongs to and is one of the oldest parts of the TCP/IP suite. The term NTP applies to both the protocol and the client-server programs that run on computers. In order to synchronize all of a EVSE's operations, the EVSE system clock 817—a small quartz crystal located on a motherboard—is used. The EVSE system clock 817 sends out a signal on a regular basis to all other EVSE components.

If a single power cycle 847 occurs without network connectivity, once the network connectivity 815 is restored it is possible to retroactively change information tracked based on a difference between a clock acquired through the NTP synchronization 842 and a date/time 850 of the system 802 believed to be in. The utilities 825 have access to an accurate data when the network connectivity 815 is power and there are power failures.

The EVSE system clock 817 will not drift by minutes or hours over the course of 90 days. The smart EVSE 805 will have accurate metering capabilities 852, and therefore can be used for sub-metering applications. The EVSE 805 is configured to be connected to a network via a user Wi-Fi® network 855 and store up to 90 days of 15-minute interval data and charging session data.

The system 802 further comprises an EV Bluetooth® device 857 of the EV 812 which is to be used instead of the short-range wireless communication capability 810 of the cellular mobile device 807. The smart EVSE 805 is configured to use an authentication process 860 that is needed to synchronize time 845 and upload data to also automatically unlock the smart EVSE 805 for charging.

The short-range wireless communication capability 810 of the cellular mobile device 807 provides a solution for the issue of dealing with poor connectivity/clock drift and power cycles. The short-range wireless communication capability 810 of the cellular mobile device 807 is based on a Bluetooth® device 865(1), a Bluetooth® device 865(2) or a ZigBee® wireless interface 870 between the EV 812 and the smart EVSE 805.

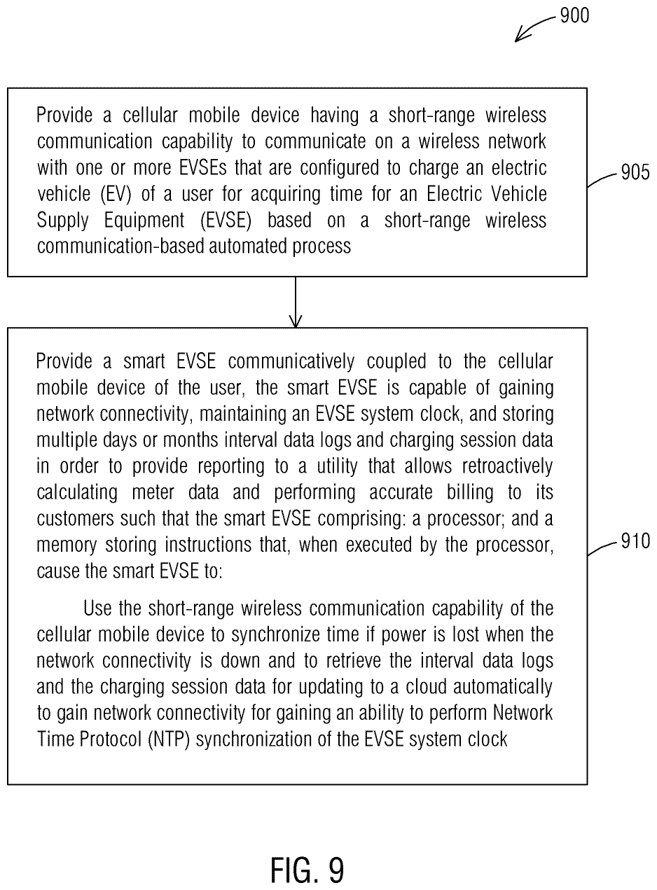

Referring to FIG. 9, it illustrates a schematic view of a flow chart of a method 900 for acquiring time for the smart Electric Vehicle Supply Equipment (EVSE) 905 based on a short-range wireless communication-based automated process in accordance with an embodiment of the present disclosure. Reference is made to the elements and features described in FIG. 8. It should be appreciated that some steps are not required to be performed in any particular order, and that some steps are optional.

The method 900 comprises a step 905 of providing a cellular mobile device having a short-range wireless communication capability to communicate on a wireless network with one or more EVSEs that are configured to charge an electric vehicle (EV) of a user for acquiring time for an Electric Vehicle Supply Equipment (EVSE) based on a short-range wireless communication-based automated process. The method 900 further comprises a step 910 of providing a smart EVSE communicatively coupled to the cellular mobile device of the user, the smart EVSE is capable of gaining network connectivity, maintaining an EVSE system clock, and storing multiple days or months interval data logs and charging session data in order to provide reporting to a utility that allows retroactively calculating meter data and performing accurate billing to its customers such that the smart EVSE comprising: a processor; and a memory storing instructions that, when executed by the processor, cause the smart EVSE to: use the short-range wireless communication capability of the cellular mobile device to synchronize time if power is lost when the network connectivity is down and to retrieve the interval data logs and the charging session data for updating to a cloud automatically to gain network connectivity for gaining an ability to perform Network Time Protocol (NTP) synchronization of the EVSE system clock.

While a design based on a short-range wireless communication capability according to a Bluetooth protocol is described here a range of one or more other short-range wireless communication protocols are also contemplated by the present disclosure. For example, other short-range wireless communication protocols such as a ZigBee protocol may be implemented based on one or more features presented above without deviating from the spirit of the present disclosure.

The techniques described herein can be particularly useful for Network Time Protocol (NTP) synchronization. While particular embodiments are described in terms of Network Time Protocol (NTP) synchronization, the techniques described herein are not limited to such Network Time Protocol (NTP) synchronization but can also be used with other Time synchronization.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

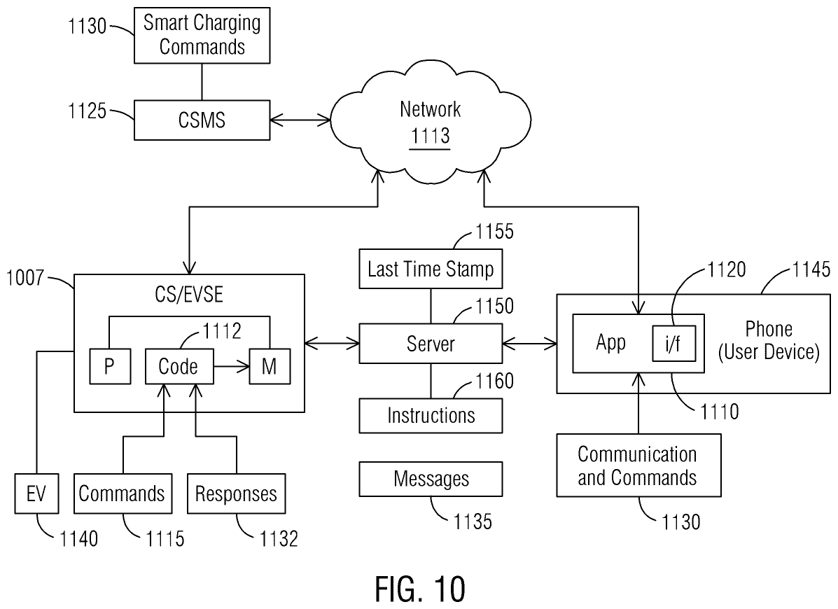

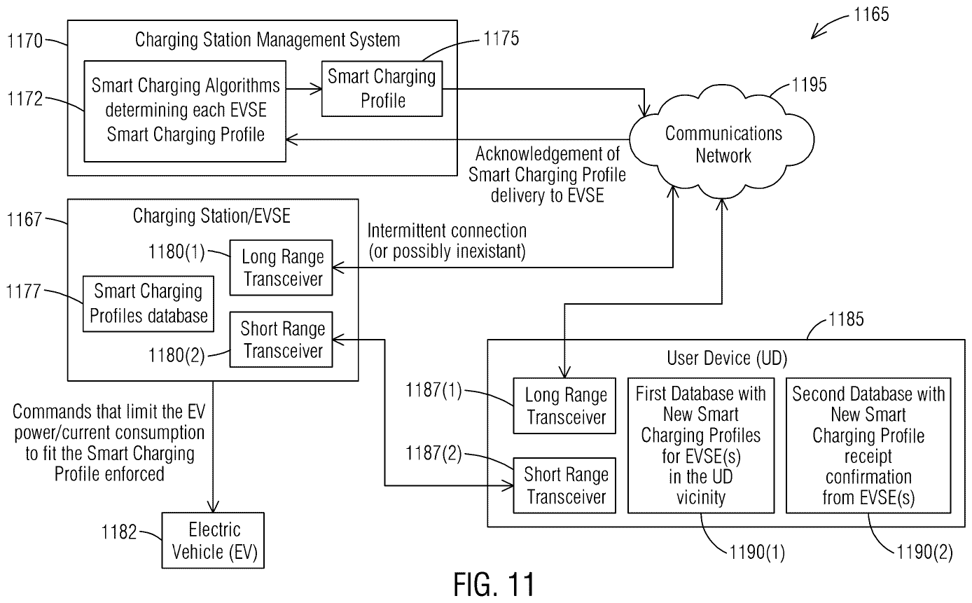

Consistent with an embodiment of the present disclosure, FIG. 10 represents a platform that that provides a system 1005 for smart charging with an offline Electric Vehicle Supply Equipment (EVSE) 1007. The system 1005 comprises a smart phone App 1110 as a baseline App. The system 1005 comprises an Electric Vehicle (EV) charger embedded software code 1112 that is configured to receive commands 1115 through Open Charge Point Protocol (OCPP) (standard communication) to perform smart charging such that the EV charger embedded software code 1112 is configured to receive commands on a network (n/w) 1113 from a smart phone application (App) interface 1120 that establishes a connectivity between the smart phone App 1110 and the EV charger/EVSE 1007. The system 1005 further comprises a Charging Station Management System (CSMS) 1125.

The smart phone App stores communication and commands 1130 to/from the Charging Station Management System (CSMS) 1125 and the EV Charger embedded software code 1112 and also stores-and-forwards the commands 1115 and responses 1132 related to the smart charging. The CSMS 1125 is configured to send smart charging commands 1130 through a direct communication with the EV charger 1007 via the OCPP such that it establishes a way for the CSMS 1125 to use the smart phone App 1110 as a bridge to send/receive information to the EVSE 1007, instead of using standard communication channels while adding to a list of messages 1135 that are sent/received messages related to the smart charging,

The Open Charge Point Protocol (OCPP) standard is an open-source communication standard that allows electric vehicle (EV) charging stations and management systems including the Charging Station Management System (CSMS) 1125 to communicate with each other. The Charging Station Management System (CSMS) 1125 is a software platform that manages multiple electric vehicle (EV) charging stations for an electric vehicle(s) (EV) 1140.

Load balancing between electric vehicle (EV) chargers is performed by making changes to power/current allocated to the EV charger(s) 1007 in a load balancing group (not shown). The changes in power allocation between the EV charger(s) 1007 is performed when one or more of the EV charger(s) 1007 in the load balancing group is offline, using a user device such as a smartphone 1145 as a commands bridge.

On top of messages sent from the EV charger 1007 to a server 1150 via the smartphone 1145, the server 1150 indicating a last time stamp 1155 sent. The server 1150 also sends smart charging instructions 1160 according to Open Charge Point Protocol (OCPP) standard thus allows the smart charging to happen with any EV chargers that are offline. The CSMS 1125 is configured to send smart charging commands 1130 through a direct communication with the EV charger 1007 via the OCPP such that it establishes a way for the CSMS 1125 to use the smart phone App 1110 as a bridge to send/receive information to the EVSE 1007, instead of using standard communication channels while adding to a list of messages 1135 that are sent/received messages related to smart charging.

The changes in power allocation between the EV chargers 1007 are performed when one or more of the EV chargers in a load balancing group is offline, using the smartphone 1145 as a commands bridge. When using the smart charging, the Charging Station Management System (CSMS) 1125 while loading smart charging-related configuration parameters into the EV chargers 1007 in a load management group, sharing a power (or current) budget so that a situation is avoided that can cause one or more safety issues or going above the power (or current) budget.

Changing a power/current allocation to different devices in a group via a safe mechanism when a certain amperage or power is moved from a first EV charger to a second EV charger. Accordingly, a first current (or power) is reduced from the first EV charger, and after confirming that this occurred and the first EV charger took a command, the same amount is added to the second EV charger that will have an increased power (or current) budget. For example, moving 10 amperes (A) from a Charger A to a Charger B involves a timing sequence of below Times 1 to 5:
a. Time 1: the Charger A has 20 A, the Charger B has 20 A.
b. Time 2: the Charger A is instructed by the CSMS to reduce from 20 A to 10 A.
c. Time 3: the Charger A confirms/acknowledges to the CSMS it now has 10 A maximum current.
d. Time 4: the Charger B is instructed by the CSMS to increase from 20 A to 30 A.
e. Time 5: the Charger B confirms/acknowledges to the CSMS it now has 30 A maximum current, wherein if both EV chargers are online, there is a direct communication between each EV charger and the CSMS while if either one or both EV chargers are offline a user device is used as a bridge between the CSMS and the EV chargers such that a method for making the bridge to happen is that it was not important about sending an entire database stored of charging session history, while in this case of smart charging what is important is understanding at what date/time a command is being sent and for what command date/time an acknowledgement message relates to.

Every user device that is in proximity with an EV charger connects to it, stores information of a last acknowledgement message, and to what it refers to and the CSMS 1125 based on arrival of an acknowledgement/confirmation knows which message each EV charger received and is able to allocate a power/current to other EV chargers accordingly.

The present disclosure allows authenticating drivers and grabbing charging session information from an EVSE to the Charging Management System (CMS), allowing normal charging to occur, with smart charging. In a system, when the phone (or electric vehicle) is connected to the EV charger via Bluetooth or another wireless interface in an authenticated manner, the phone delivers to the charger OCPP (Open Charge Point Protocol (OCPP) is an open-source communication standard that allows electric vehicle (EV) charging stations to communicate with each other) Smart Charging Profile configuration messages of OCPP 1.6J, 2.0.1, 2.1 or later variants (See OCPP—Open Charge Alliance), with a timestamp of when the configuration was last changed on the CMS. An app on the phone (or the electric vehicle) compares the timestamp of the configuration (phone time acquisition, in case the phone lost energy and then uses the latest configuration. If the configuration coming from the phone is newer than the previously stored one, it informs the phone.

When the phone, vehicle, or EVSE has internet connectivity, it informs the CMS about the EVSE having received the OCPP configuration information related to Smart Charging. This method can be used for all OCPP configuration messages, especially how smart charging is used.

If upon connection between the EV charger and electric vehicle the state of charge of the electric vehicle is given to the EV charger via ISO15118-20, the EV charger provides the electric vehicle State of Charge to the app on the phone. If the app is running on the electric vehicle, State of Charge is known.

While using Smart Charging profiles is useful to ensure charging happens when it is most preferable for either the driver (to reduce electricity costs for the driver) or the utility (to avoid bottlenecks on the grid), drivers may be allowed to override smart charging events. In these cases, normally drivers need to receive a notification about the impact of overriding (e.g. you will pay a higher electricity rate), and then be allowed to nevertheless override, allowing the driver to charge the electric vehicle.

Therefore, if upon plugging the electric vehicle authenticating, charging is not to start immediately because the smart charging profile determines that this is not a good time to charge, the driver should be allowed to override and initiate charging. In this scenario, the app would generate an additional Smart Charging profile with higher priority that enables charging for enough time to charge the electric vehicle battery, based on the electric vehicle battery size configured on the app, or the State of Charge of the electric vehicle battery (if known), or a maximum logical size for a battery and the minimum between the maximum output power of an EV charger of this model and the maximum power consumption vehicle of this type.

This charging profile and the fact that the driver overrode the default configuration is then registered at the CMS, once the phone, electric vehicle (or EVSE) has connection with the CMS, as this can change the benefits the driver receives if the driver is enrolled in a utility day ahead demand response program.

FIG. 11 illustrates a system 1165 for smart charging with an offline Electric Vehicle Supply Equipment (EVSE) 1167 in accordance with an embodiment of the present disclosure. The system 1165 comprises a CSMS 1170 including smart charging algorithms 1172 and a smart charging profile 1175. The EVSE 1167 comprises a smart charging profiles database 1177, a long-range transceiver 1180(1) and a short-range transceiver 1180(2). The EVSE 1167 is configured to charge an EV 1182. The system 1165 comprises a user device (UD) 1185 a long-range transceiver 1187(1), a short-range transceiver 1187(2), a first database 1190(1) and a second database 1190(2). The CSMS 1170, the EVSE 1167 and the user device 1185 are connected via a communications network 1195 and together provide smart charging of the offline Electric Vehicle Supply Equipment (EVSE) 1167.

The first database 1190(1) includes new smart charging profiles 1175 for EVSE(s) 1167 in the user device 1185 vicinity. The second database 1190(2) includes a new smart charging profile receipt confirmation from EVSE(s) 1167.

FIG. 11 shows the system 1165 that comprises five key elements, which have the following functions. Charging Station Management System (CSMS) 1170 is responsible for running the smart charging algorithms 1172 that determine what is the power (or current) to be allocated to each Charging Station (or EVSE) 1167. A power allocation may be necessary because there is a power contract limitation, which does not allow the charging stations 1167 to collectively consume more than a power budget that is lower than the sum of the maximum power that each charging station 1167 can theoretically deliver. A current allocation may be necessary because there is a physical limitation on the circuit to which the charging stations 1167 are connected which is lower than the sum of the maximum AC currents that each charging station 1167 may consume.

The Charging Station Management System 1170 generates Smart Charging Profiles 1175, one for each of the charging stations 1167 to which it is connected. Each profile 1175 indicates the maximum power (or current) each charging station 1167 can send to the electric vehicles 1182 connected to it. An algorithm to allocate power (or current) to different charging stations 1167 will or can depend on different criteria, like which electric vehicle 1182 occupied a charging station first (or last), the state of charge of each vehicle battery, etc. The CSMS 1170 sends a Smart Charging Profile 1175 to each charging station 1167 and receives an acknowledgement.

The communications network 1195 is used to send messages between the CSMS 1170 and the user device 1185, as well as the CSMS 1170 and a charging station 1167. Since the user device 1185 is mobile, it may or may not be in locations that have connectivity to the communications network 1195, though it is expected that it does have connectivity at certain points in time, as this is typically a cellphone/smartphone or tablet. The EVSE 1167 may be deployed in a location in which connectivity with the communications network 1195 is intermittent or possibly never present. When connectivity between the CSMS 1170 and the EVSE 1167 is not possible directly through the communications network 1195, messages are sent to the user device 1185, which serves as a bridge between the two.

The user device 1185 is used to locally interface with the EVSE 1167 in order to deliver messages that it received from the CSMS 1170 towards the EVSE 1167, and vice-versa. Among these messages, there are Smart Charging Profile messages, as well as acknowledgement messages from the EVSE 1167 towards the CSMS 1170 that the Smart Charging Profile 1175 was received. Since user devices 1185 may have a limited storage space for messages, only messages coming from the CSMS 1170 towards the EVSE 1167 related to the EVSEs 1167 in the physical vicinity of the user device 1185 are stored on the user device 1185. When the user device 1185 sends messages either from the EVSE 1167 towards the CSMS 1170 via the communications network 1195, or from the CSMS 1170 towards the EVSE 1167 locally (using the short-range transceiver), the messages are erased from the storage.

The EVSE 1167 receives the smart charging profiles 1175 from the CSMS 1170 and sends acknowledgement of receipt, either through the communications network 1195 (using its long-range transceiver 1180(1)) or through the user device 1185 (using its local, short-range transceiver 1187(2)) sends commands to the electric vehicle 1182 with an allocation of maximum power (or current) to consume. The electric vehicle 1182 receives commands from the EVSE 1167 on how much power (or current) it can consume and limits its power (or current) consumption to this level.

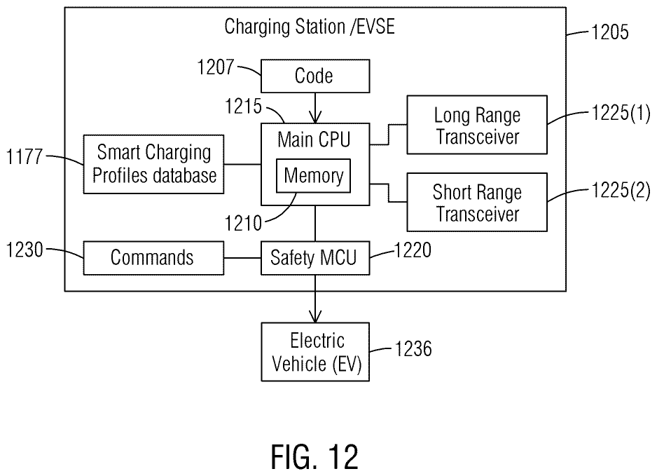

As shown in FIG. 12, a Charging Station/EVSE 1205 includes a code (e.g., software instructions) 1207 that is stored in a memory 1210 of a main computing unit (MCU) 1215 and runs mainly inside the main CPU 1215 (although some of it can run on a safety MCU 1220). The Charging Station/EVSE 1205 has at least on CPU in which it runs software (code) 1207. The main CPU 1215 is connected to both long-and short-range transceivers 1225(1-2). The safety MCU 1220 sends commands 1230 limiting power consumption to an electric vehicle. The main CPU 1215 has access to a Smart Charging Profiles database 1235.

There are some pre-requisites to the smart charging process. In particular, an EV Driver of an EV 1236 installs an application on a phone, compatible with a cloud backend and an EV charger. The EV Driver carriers the phone in which the app is installed when he/she desires to perform EV charging. When the EV charger was never used for charging purposes, it has no record of offline transactions. If electric vehicle charging happens while the EV charger is offline, without any local, wide or personal area network communication, all charging records of energy, power, current, voltage, maximum power/current configuration and authorization are stored on an EV charger's internal memory, including a time stamp at which each transaction occurred. When the EV driver's phone is in a geographic area, the cloud sends to the EV driver's phone app the list of time stamps of the last transactions that it has recorded for all EV chargers in the same geographic area, with a configurable radius.

An algorithm for the smart charging is described next. When the EV driver approaches an EV charger, a phone connects to the EV charger using Bluetooth protocol present at both the EV charger and the phone (Bluetooth protocol is going to be used as it is a personal area network (PAN), but other PANs present at the EV charger and the phone could also be used).

While the phone is connected to the charger: the phone indicates to the EV charger what is the time stamp of the last transaction that the server has stored for that EV charger.

The EV charger deletes from its internal memory all transactions older than the last time stamp the server has transactions for. A deletion of messages therefore happens when there is confirmation that the cloud received the messages.

The EV charger sends to the phone a summary of all transactions that happened offline since the last transaction for which the server has a record and does not delete these transactions.

When the phone reaches a location in which it has network coverage, it sends to a cloud backend server all the messages that came from the EV charger it previously stored.

Every time the server receives new messages from the phone app, coming from a specific EV charger, the last known message time stamp for that EV charger is updated.

If for whatever reason more than one phone sends the same messages to the cloud backend server, these duplicate messages are ignored.

This mechanism ensures that even if a phone is lost/erased, there is no chance that messages are lost, as they are stored on all phones that are close to the EV charger, until the EV charger has confirmation from one of the phones that the messages were received by the cloud backend server. In exemplary embodiments, the above set forth algorithm is shown and described in U.S. patent application Ser. No. 18/617,376 entitled BLUETOOTH CERTIFICATE BASED AUTHENTICATION FOR ELECTRIC VEHICLE CHARGING ENABLEMENT, which was filed on Mar. 26, 2024. In the present disclosure, on top of messages sent from the EV charger to the server via the phone, and the server indicating the last time stamp send, the server also sends smart charging instructions according to the OCPP standard. This algorithm allows smart charging to happen with EV chargers that are offline. For smart charging, a smartphone as a commands bridge makes changes to the power/current allocated to EV chargers in a load balancing group for Load Balancing between EV chargers. So, the smartphone has an application (APP) that controls the offline EV charger's configuration parameters such as power/current for load balancing.

The EV charger embedded software code is capable of receiving commands through OCPP (standard communication) in order to perform smart charging. The EV charger embedded software code needs to be able to receive commands from the smart phone App interface instead. Note that the connectivity between the smart phone app and the EV charger is established for other purposes.

The smart phone app has stored communication and commands to/from a CSMS and the EV Charger embedded software code. The algorithm is to store-and-forward commands and responses related to smart charging. The CSMS sends smart charging commands through a direct communication with the EV charger via OCPP. The CSMS uses the smart phone app as a bridge to send/receive information to the EVSE, instead of using standard communication channels. This algorithm adds to the list of messages that are sent/received messages related to smart charging.

Load Balancing/Load Management can be used interchangeably and consists of distributing a current or power budget between EV chargers in a load management/balancing group. The power (or current) budget can be fixed or dynamic. A fixed budget normally infers a physical or contractual boundary that should be exceeded in power (or current) consumption. For example, if multiple EV chargers are connected to a circuit breaker that can support at most 100 A, the current budget would be 100 A, which is to be shared between all EV chargers connected to the same circuit breaker. The load balancing group could be managed by one of the EV chargers in the group, by an external hardware appliance or, in the case of our algorithm, by the CSMS A dynamic load balancing group would infer that the budget changes over time, i.e., either there is local power generation (by solar, for example, or a managed battery), or another load consuming energy on that same location (e.g. air conditioners, batteries, etc.).

Load balancing requires a) EV chargers (that execute the commands and give information to the CSMS) b) CSMS (that provides commands to the EV chargers based on the overall budget, and the status of the EV chargers in the group) c) a method to relay messages between the EV chargers and the CSMS. In a normal online scenario, this would be the internet. In the case of the present algorithm, the method to relay messages is using the smart phone app as a bridge.

The term “a power budget” is the total amount of power allowed by a group of EV chargers to consume. It is split between EV charges by the CSMS. For example, if the power budget is 100 kW, and there are 10 EV chargers that can consume up to 11.5 kW in a group, the CSMS may divide it equally, 10×10 kW. Without load management. However, if all 10 EV chargers would consume 11.5 kW each, the total consumption would be 115 kW, which would exceed the power budget. The CSMS can monitor actual power consumption by different EV chargers and can move part of the power budget from one EV charger to the other. In situations in which the smart phone running the app has cellular coverage, it serves as the bridge possibly between more than one EV charger at the same time, allowing the CSMS to actually move the power allocation from one EV charger to the other within the group, without exceeding the power budget. These moves of current from one to the other, if done correctly, guarantee the power budget is not exceeded. Exceeding the power budget may represent a safety issue.

For example, (in moving 10 A from Charger A to Charger B), if both EV chargers are online, there is a direct communication between each EV charger and the CSMS. If either one or both EV chargers are offline, a user device (e.g., a smartphone) is used as a bridge between the CSMS and the two EV chargers. The method for making this bridge does not involve sending an entire database stored of a charging session history, while in the case of smart charging what is important is understanding at what date/time the command is being sent, and for what command date/time the acknowledgement message relates to. Every user device (e.g., smartphones) that is in proximity with an EV charger connects to it, stores the information of the last acknowledgement message, and to what it refers to. The CSMS, based on the arrival of acknowledgement/confirmation, knows which message each offline EV charger was received, and is able to allocate the power/current to other offline EV chargers accordingly. Load Balancing between EV chargers requires making changes to the power/current allocated to EV chargers in a load balancing group in a safe and efficient manner. The idea allows performing changes in power allocation between EV chargers when one or more of the EV chargers in a load balancing group is offline, using a smartphone as a commands bridge. When smart charging is used, a rule of thumb used by a CSMS when loading smart charging-related configuration parameters into EV chargers in a load management group, is that a power (or current) budget is to be shared so that there is never a situation that can cause safety issues or going above a power budget. A safe mechanism for changing the power/current allocation to different devices in a group would be that when a certain amperage or power is moved from an EV charger to another, that first the current (or power) is reduced from one EV charger, and after confirming that this occurred and the EV charger took the command, the same amount is added to the charger that will have an increased power budget. The present disclosure includes a concept of smart charging commands to the communication that already happens in this offline fashion, through a cellphone. Not only charging session information and charging authorization commands to be sent, but now smart charging instructions and confirmation that the EV charger adopted the smart charging instructions are also sent.

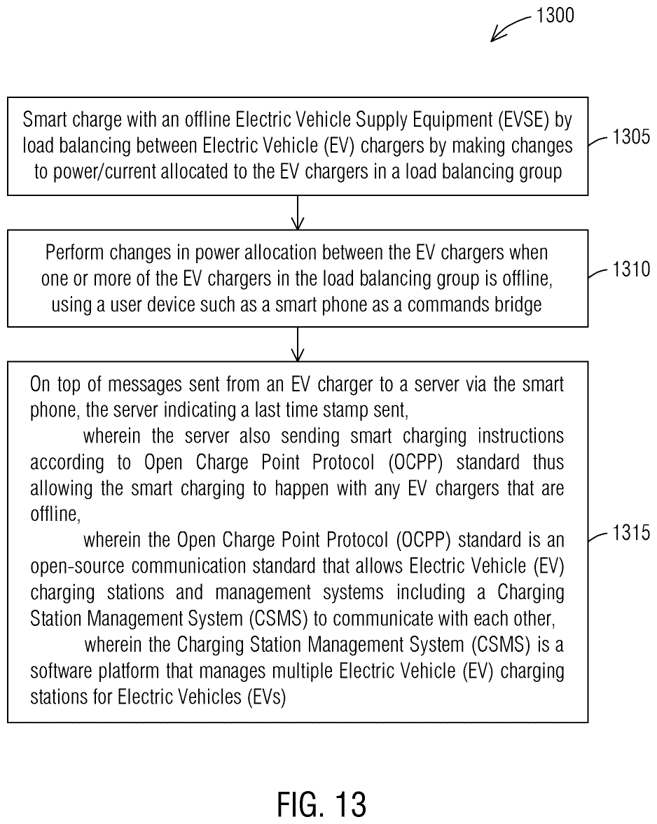

FIG. 13 illustrates a schematic view of a flow chart for a method 1300 of smart charging with an offline Electric Vehicle Supply Equipment (EVSE) according to an embodiment of the present disclosure. Reference is made to the elements and features described in FIGS. 1-12. It should be appreciated that some steps are not required to be performed in any particular order, and that some steps are optional.

The method 1300 comprises a step 1305 of load balancing between electric vehicle (EV) chargers by making changes to power/current allocated to the EV chargers in a load balancing group. The method 1300 further comprises a step 1310 of performing changes in power allocation between the EV chargers when one or more of the EV chargers in the load balancing group is offline, using a user device such as a smartphone as a commands bridge. The method 1300 further comprises a step 1315 of on top of messages sent from an EV charger to a server via the smartphone, the server indicating a last time stamp sent. The server also sending smart charging instructions according to Open Charge Point Protocol (OCPP) standard thus allowing the smart charging to happen with any EV chargers that are offline. The Open Charge Point Protocol (OCPP) standard is an open-source communication standard that allows electric vehicle (EV) charging stations and management systems including a Charging Station Management System (CSMS) to communicate with each other. The Charging Station Management System (CSMS) is a software platform that manages multiple electric vehicle (EV) charging stations for electric vehicles (EVs).

While a platform of a smart charging system based on smart charging instructions and confirmation that an EV charger adopted the smart charging instructions is disclosed. Other platforms may be implemented based on one or more features presented above without deviating from the spirit of the present disclosure.

The techniques described herein can be particularly useful for smart charging of one or more offline EVSEs. While particular embodiments are described in terms of offline EVSEs with a new code, a CSMS, a new app and a server, the techniques described herein are not limited to such combination but can also be used with other combinations of components implemented in EV hardware or EV software.

While embodiments of the present disclosure have been disclosed in exemplary forms, it will be apparent to those skilled in the art that many modifications, additions, and deletions can be made therein without departing from the spirit and scope of the disclosure and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the disclosure has been described with reference to specific embodiments. However, one of ordinary skill in the art appreciates that various modifications and changes can be made without departing from the scope of the disclosure. Accordingly, the specification and figures are to be regarded in an illustrative rather than a restrictive sense, and all such modifications are intended to be included within the scope of disclosure.

Although the disclosure has been described with respect to specific embodiments thereof, these embodiments are merely illustrative, and not restrictive of the disclosure. The description herein of illustrated embodiments of the disclosure is not intended to be exhaustive or to limit the disclosure to the precise forms disclosed herein (and in particular, the inclusion of any particular embodiment, feature or function is not intended to limit the scope of the disclosure to such embodiment, feature or function). Rather, the description is intended to describe illustrative embodiments, features and functions in order to provide a person of ordinary skill in the art context to understand the disclosure without limiting the disclosure to any particularly described embodiment, feature or function. While specific embodiments of, and examples for, the disclosure are described herein for illustrative purposes only, various equivalent modifications are possible within the spirit and scope of the disclosure, as those skilled in the relevant art will recognize and appreciate. As indicated, these modifications may be made to the disclosure in light of the foregoing description of illustrated embodiments of the disclosure and are to be included within the spirit and scope of the disclosure. Thus, while the disclosure has been described herein with reference to particular embodiments thereof, a latitude of modification, various changes and substitutions are intended in the foregoing disclosures, and it will be appreciated that in some instances some features of embodiments of the disclosure will be employed without a corresponding use of other features without departing from the scope and spirit of the disclosure as set forth. Therefore, many modifications may be made to adapt a particular situation or material to the essential scope and spirit of the disclosure.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the disclosure.

In the description herein, numerous specific details are provided, such as examples of components and/or methods, to provide a thorough understanding of embodiments of the disclosure. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the disclosure. While the disclosure may be illustrated by using a particular embodiment, this is not and does not limit the disclosure to any particular embodiment and a person of ordinary skill in the art will recognize that additional embodiments are readily understandable and are a part of this disclosure.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. A method of smart charging with an offline Electric Vehicle Supply Equipment (EVSE), the method comprising:
load balancing between electric vehicle (EV) chargers by making changes to power/current allocated to the EV chargers in a load balancing group;
performing changes in power allocation between the EV chargers when one or more of the EV chargers in the load balancing group is offline, using a user device such as a smartphone as a commands bridge; and
on top of messages sent from an EV charger to a server via the smartphone, the server indicating a last time stamp sent,
wherein the server also sending smart charging instructions according to Open Charge Point Protocol (OCPP) standard thus allowing the smart charging to happen with any EV chargers that are offline,
wherein the Open Charge Point Protocol (OCPP) standard is an open-source communication standard that allows electric vehicle (EV) charging stations and management systems including a Charging Station Management System (CSMS) to communicate with each other, and
wherein the Charging Station Management System (CSMS) is a software platform that manages multiple electric vehicle (EV) charging stations for electric vehicles (EVs).

2. The method of claim 1, further comprising:
performing changes in power allocation between the EV chargers when one or more of the EV chargers in a load balancing group is offline, using a smartphone as a commands bridge.

3. The method of claim 2, further comprising:
when using the smart charging, the Charging Station Management System (CSMS) while loading smart charging-related configuration parameters into the EV chargers in a load management group, sharing a power (or current) budget so that a situation is avoided that can cause one or more safety issues or going above the power (or current) budget.

4. The method of claim 3, further comprising:
changing a power/current allocation to different devices in a group via a safe mechanism when a certain amperage or power is moved from a first EV charger to a second EV charger such that first current (or power) is reduced from the first EV charger, and after confirming that this occurred and the first EV charger took a command, the same amount is added to the second EV charger that will have an increased power (or current) budget.

5. The method of claim 4, wherein an EV charger embedded software code can receive commands through OCPP (standard communication) to perform the smart charging such that the EV charger embedded software code is configured to receive commands from a smart phone application (App) interface that establishes a connectivity between the smart phone App and an EV charger.

6. The method of claim 5, wherein the smart phone App is a baseline App stores communication and commands to/from the CSMS, and the EV Charger embedded software code and also stores-and-forwards commands and responses related to the smart charging.

7. The method of claim 6, wherein the CSMS is configured to send smart charging commands through a direct communication with the EV charger via the OCPP such that it establishes a way for the CSMS to use the smart phone App as a bridge to send/receive information to the EVSE, instead of using standard communication channels while adding to a list of messages that are sent/received messages related to the smart charging.

8. The method of claim 3, wherein moving 10 amperes (A) from a Charger A to a Charger B involves a timing sequence of below Times 1 to 5:
a. Time 1: the Charger A has 20 A, the Charger B has 20 A,
b. Time 2: the Charger A is instructed by the CSMS to reduce from 20 A to 10 A,
c. Time 3: the Charger A confirms/acknowledges to the CSMS it now has 10 A maximum current,
d. Time 4: the Charger B is instructed by the CSMS to increase from 20 A to 30 A, and
e. Time 5: the Charger B confirms/acknowledges to the CSMS it now has 30 A maximum current.

9. The method of claim 8, wherein if both EV chargers are online, there is a direct communication between each EV charger and the CSMS while if either one or both EV chargers are offline a user device is used as a bridge between the CSMS and the EV chargers such that a method for making the bridge to happen is that it was not important about sending an entire database stored of charging session history, while in this case of smart charging what is important is understanding at what date/time a command is being sent and for what command date/time an acknowledgement message relates to.

10. The method of claim 9, wherein every user device that is in proximity with an EV charger connects to it, stores information of a last acknowledgement message, and to what it refers to and the CSMS based on the arrival of acknowledgement/confirmation knows which message each EV charger received and is able to allocate a power/current to other EV chargers accordingly.

11. A system of smart charging with an offline Electric Vehicle Supply Equipment (EVSE), the system comprising:
a smart phone App as a baseline App;
an Electric Vehicle (EV) charger embedded software code that is configured to receive commands through Open Charge Point Protocol (OCPP) (standard communication) to perform smart charging such that the EV charger embedded software code is configured to receive commands from a smart phone application (App) interface that establishes a connectivity between the smart phone App and an EV charger; and
a Charging Station Management System (CSMS),
wherein the smart phone App stores communication and commands to/from the Charging Station Management System (CSMS) and the EV Charger embedded software code and also stores-and-forwards commands and responses related to the smart charging,
wherein the CSMS is configured to send smart charging commands through a direct communication with the EV charger via the OCPP such that it establishes a way for the CSMS to use the smart phone App as a bridge to send/receive information to the EVSE, instead of using standard communication channels while adding to a list of messages that are sent/received messages related to the smart charging,
wherein the Open Charge Point Protocol (OCPP) standard is an open-source communication standard that allows electric vehicle (EV) charging stations and management systems including the Charging Station Management System (CSMS) to communicate with each other, and
wherein the Charging Station Management System (CSMS) is a software platform that manages multiple electric vehicle (EV) charging stations for electric vehicles (EVs).

12. The system of claim 11, wherein load balancing between electric vehicle (EV) chargers is performed by making changes to power/current allocated to the EV chargers in a load balancing group.

13. The system of claim 12, wherein changes in power allocation between the EV chargers is performed when one or more of the EV chargers in the load balancing group is offline, using a user device such as a smartphone as a commands bridge.

14. The system of claim 13, wherein on top of messages sent from an EV charger to a server via the smartphone, the server indicating a last time stamp sent, and
wherein the server also sending smart charging instructions according to Open Charge Point Protocol (OCPP) standard thus allowing the smart charging to happen with any EV chargers that are offline.

15. The system of claim 14, wherein the CSMS is configured to send smart charging commands through a direct communication with the EV charger via the OCPP such that it establishes a way for the CSMS to use the smart phone App as a bridge to send/receive information to the EVSE, instead of using standard communication channels while adding to a list of messages that are sent/received messages related to smart charging.

16. The system of claim 15, wherein changes in power allocation between the EV chargers are performed when one or more of the EV chargers in a load balancing group is offline, using a smartphone as a commands bridge.

17. The system of claim 16, wherein when using the smart charging, the Charging Station Management System (CSMS) while loading smart charging-related configuration parameters into the EV chargers in a load management group, sharing a power (or current) budget so that a situation is avoided that can cause one or more safety issues or going above the power (or current) budget.

18. The system of claim 17, wherein changing a power/current allocation to different devices in a group via a safe mechanism when a certain amperage or power is moved from a first EV charger to a second EV charger such that first current (or power) is reduced from the first EV charger, and after confirming that this occurred and the first EV charger took a command, the same amount is added to the second EV charger that will have an increased power (or current) budget.

19. The system of claim 11, wherein moving 10 amperes (A) from a Charger A to a Charger B involves a timing sequence of below Times 1 to 5:
a) Time 1: the Charger A has 20 A, the Charger B has 20 A,
b) Time 2: the Charger A is instructed by the CSMS to reduce from 20 A to 10 A,
c) Time 3: the Charger A confirms/acknowledges to the CSMS it now has 10 A maximum current,
d) Time 4: the Charger B is instructed by the CSMS to increase from 20 A to 30 A, and
e) Time 5: the Charger B confirms/acknowledges to the CSMS it now has 30 A maximum current, wherein if both EV chargers are online, there is a direct communication between each EV charger and the CSMS while if either one or both EV chargers are offline a user device is used as a bridge between the CSMS and the EV chargers such that a method for making the bridge to happen is that it was not important about sending an entire database stored of charging session history, while in this case of smart charging what is important is understanding at what date/time a command is being sent and for what command date/time an acknowledgement message relates to.

20. The system of claim 19, wherein every user device that is in proximity with an EV charger connects to it, stores information of a last acknowledgement message, and to what it refers to and the CSMS based on the arrival of acknowledgement/confirmation knows which message each EV charger received and is able to allocate a power/current to other EV chargers accordingly.
